(19) United States
(12) Patent Application Publication
(10) Pub. No.: US 2016/0127309 A1
(43) Pub. Date: May 5, 2016

(54) METHOD FOR PREVENTING COLLISIONS BETWEEN ADDRESSES IN DEVICE-TO-DEVICE COMMUNICATIONS

(71) Applicant: Electronics and Telecommunications Research Institute, Daejeon (KR)

(72) Inventors: Mi Young YUN, Daejeon (KR); Kyoung Seok LEE, Daejeon (KR); Ae Soon PARK, Daejeon (KR); Jae Sheung SHIN, Daejeon (KR)

(21) Appl. No.: 14/932,034

(22) Filed: Nov. 4, 2015

(30) Foreign Application Priority Data
Nov. 4, 2014 (KR) 10-2014-0152412
Nov. 2, 2015 (KR) 10-2015-0152906

(51) Int. Cl. H04L 29/12; H04W 8/26; H04W 4/00

(52) U.S. Cl. CPC H04L 61/2046; H04W 4/005; H04W 8/26; H04L 61/2007; H04L 61/103

(57) ABSTRACT

Methods for preventing address collisions in device-to-device (D2D) communications are disclosed. An operation method of a first terminal in a wireless communication network may comprise configuring an internet protocol (IP) address of the first terminal used for D2D communications; generating an announcement frame based on an address resolution protocol (ARP) including the IP address; and transmitting the announcement frame. Thus, a problem of collisions between IP addresses in D2D communications can be resolved.

### CROSS-REFERENCE TO RELATED APPLICATIONS

This application claims priorities to Korean Patent Application No. 10-2014-0152412 filed on Nov. 4, 2014 and Korean Patent Application No. 10-2015-0152906 filed on Nov. 2, 2015 in the Korean Intellectual Property Office (KIPO), the entire contents of which are hereby incorporated by reference.

### BACKGROUND

1. Technical Field

The present disclosure relates to a wireless communication technology, and more specifically, to methods for preventing collisions between internet protocol (IP) addresses in device-to-device (D2D) communications.

2. Related Art

In a cellular communication network, a user equipment (UE) may generally transmit and receive a data unit through a base station. For example, when a data unit to be transmitted to a second UE exits, a first UE may generate a frame including the data unit to be transmitted to the second UE, and transmit the generated frame to a first base station to which the first UE belongs. The first base station may receive the frame from the first UE, and identify that a destination of the received frame is the second UE. The first base station may transmit the frame to a second base station to which the second UE, as the identified destination, belongs. The second base station may receive the frame from the first base station, and identify that the destination of the received frame is the second UE. The second base station may transmit the frame to the second UE as the identified destination. The second UE may receive the frame from the second base station, and obtain the data unit included in the received frame.

Meanwhile, device-to-device (D2D) communications may mean that a UE communicates directly with another UE. For example, when a data unit to be transmitted to the second UE exists, the first UE may generate a frame including the data unit to be transmitted to the second UE, and directly transmit the generated frame to the second UE. The second UE may receive the frame from the first UE, and obtain the data unit included in the received frame.

An internet protocol (IP) address of a terminal performing D2D communications (hereinafter, referred to as ‘D2D terminal’) may be configured by a network. However, in a case that the IP address of the D2D terminal is not configured by a network, the D2D terminal may directly configure its IP address. In this case, a plurality of D2D terminals may have the same IP address. Accordingly, collisions between IP addresses may occur when D2D communications are performed.

### SUMMARY

Accordingly, exemplary embodiments of the present disclosure provide methods for preventing collisions between IP addresses in D2D communications.

In order to achieve the objective of the present disclosure, an operation method of a first terminal in a wireless communication network may comprise configuring an internet protocol (IP) address of the first terminal used for device-to-device (D2D) communications; generating an address resolution protocol (ARP) based announcement frame including the IP address; and transmitting the announcement frame.

Here, the announcement frame may include a packet data convergence protocol (PDCP) header, and the PDCP header may include an indicator indicating that the announcement frame includes an ARP packet.

Here, the announcement frame may include an ARP packet, and a hardware type field included in an ARP header of the ARP packet may indicate a hardware used for the D2D communications.

Here, the announcement frame may include an ARP packet, and a target protocol address field included in an ARP header of the ARP packet may include the IP address.

Here, the first terminal may include a medium access control (MAC) entity and an ARP entity, and the MAC entity may transmit an indicator instructing to generate the announcement frame to the ARP entity.

Here, the first terminal may include a PDCP entity, and the PDCP entity may not perform header compression on an ARP packet included in the announcement frame.

Here, the announcement frame may include a radio bearer identifier (RBID) and a logical channel index (LCID).

Here, the announcement frame may be generated after completion of configuration for the D2D communications, when the IP address is a reconfigured IP address due to IP address collision, when a frame including the IP address has not been transmitted by the first terminal during a predetermined time, or when a source address of a frame received from another terminal is identical to the IP address.

In order to achieve the objective of the present disclosure, an operation method of a first terminal in a wireless communication network may comprise configuring an internet protocol (IP) address of the first terminal used for device-to-device (D2D) communications; receiving an address resolution protocol (ARP) based announcement frame including an IP address of a second terminal; and determining whether the IP address of the first terminal is identical to the IP address of the second terminal or not.

Here, the announcement frame may include a packet data convergence protocol (PDCP) header, and the PDCP header may include an indicator indicating that the announcement frame includes an ARP packet.

Here, the announcement frame may include an ARP packet, and a hardware type field included in an ARP header of the ARP packet may indicate a hardware used for the D2D communications.

Here, the announcement frame may include an ARP packet, and a target protocol address field included in an ARP header of the ARP packet may include the IP address of the second terminal.

Here, the first terminal may include a PDCP entity, and the PDCP entity may not perform header compression on an ARP packet included in the announcement frame.

Here, the announcement frame may include a radio bearer identifier (RBID) and a logical channel index (LCID).

Here, the operation method may further comprise changing the IP address of the first terminal when the IP address of the first terminal is identical to the IP address of the second terminal.

Here, the operation method may further comprise transmitting a request frame requesting to change the IP address of the second terminal to the second terminal when the IP address of the first terminal is identical to the IP address of the second terminal

According to the exemplary embodiments of the present disclosure, the D2D terminal may generate an ARP-based announcement frame including its IP address, and transmit the generated announcement frame. The D2D terminal receiving the announcement frame may determine whether its IP address is identical to the IP address included in the received announcement frame. When it is determined that the IP address of the D2D terminal receiving the announcement frame is identical to the IP address included in the announcement frame, the D2D terminal may change its IP address, or request the D2D terminal transmitting the announcement frame to change its IP address. Therefore, collisions between IP addresses in D2D communications may be resolved.

Also, the D2D terminal may be configured to transmit the announcement frame when a predetermined event occurs. Accordingly, an overhead caused by transmission of the announcement frame may be reduced.

### BRIEF DESCRIPTION OF DRAWINGS

Exemplary embodiments of the present invention will become more apparent by describing in detail exemplary embodiments of the present invention with reference to the accompanying drawings, in which:

FIG. 1 is a conceptual diagram illustrating a first exemplary embodiment of a wireless communication network;

FIG. 2 is a conceptual diagram illustrating a second exemplary embodiment of a wireless communication network;

FIG. 3 is a conceptual diagram illustrating a third exemplary embodiment of a wireless communication network;

FIG. 4 is a conceptual diagram illustrating a fourth exemplary embodiment of a wireless communication network;

FIG. 5 is a block diagram illustrating an exemplary embodiment of a communication node constituting a wireless communication network;

FIG. 6 is a sequence chart illustrating a method of preventing collisions between IP addresses in D2D communications according to an exemplary embodiment of the present disclosure;

FIG. 7 is a block diagram illustrating entities included in a terminal performing D2D communications includes;

FIG. 8 is a block diagram illustrating an ARP header included in an announcement frame;

FIG. 9 is a block diagram illustrating a PDCP entity included in a terminal; and

FIG. 10 is a block diagram illustrating a PDCP header included in an announcement frame.

### DETAILED DESCRIPTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific example embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described in greater detail with reference to the accompanying drawings. In order to facilitate general understanding in describing the present invention, the same components in the drawings are denoted with the same reference signs, and repeated description thereof will be omitted.

A wireless communication network to which exemplary embodiments according to the present discloser applied will be described below. The wireless communication network to which exemplary embodiments according to the present discloser applied is not restricted to following description, and exemplary embodiments according to the present discloser may be applied to various wireless communication networks.

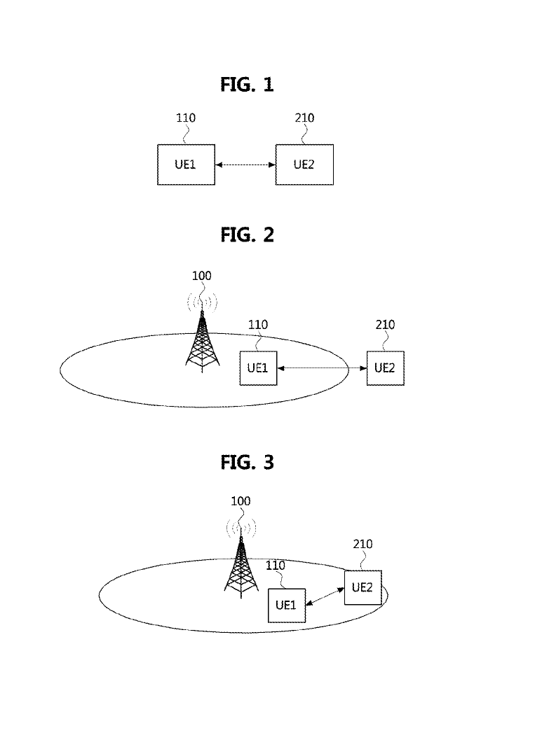

FIG. 1 is a conceptual diagram illustrating a first exemplary embodiment of a wireless communication network.

Referring to FIG. 1, each of a first terminal (e.g., user equipment) 110 and a second terminal 210 may be located outside of a cell coverage of a base station. When the first terminal 110 has a frame to be transmitted to the second terminal 210, the first terminal 110 may directly transmit the frame to the second terminal 210. The first terminal 110 may directly receive a frame from the second terminal 210. That is, each of the first terminal 110 and the second terminal 210 may transmit or receive a frame via D2D communications.

FIG. 2 is a conceptual diagram illustrating a second exemplary embodiment of a wireless communication network.

Referring to FIG. 2, the first terminal 110 may be located within a cell coverage of a first base station 100, and the second terminal 210 may be located outside the cell coverage of the first base station 100. When the first terminal 110 has a frame to be transmitted to the second terminal 210, the first terminal 110 may directly transmit the frame to the second terminal 210. The first terminal 110 may directly receive a frame from the second terminal 210. That is, each of the first terminal 110 and the second terminal 210 may transmit or receive a frame via D2D communications.

FIG. 3 is a conceptual diagram illustrating a third exemplary embodiment of a wireless communication network.

Referring to FIG. 3, each of the first terminal 110 and the second terminal 210 may be located within the cell coverage of the first base station 100. When the first terminal 110 has a frame to be transmitted to the second terminal 210, the first terminal 110 may directly transmit the frame to the second terminal 210. The first terminal 110 may directly receive a frame from the second terminal 210. That is, each of the first terminal 110 and the second terminal 210 may transmit or receive a frame via D2D communications.

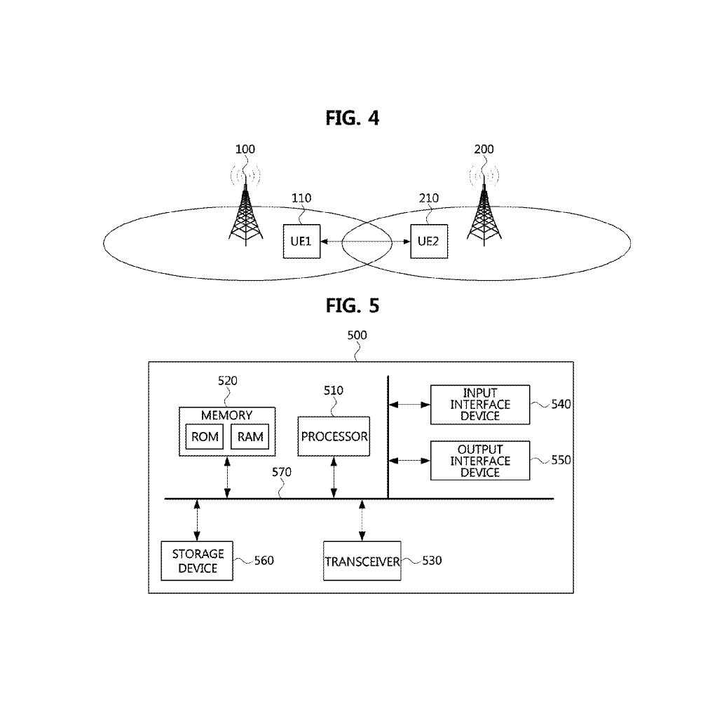

FIG. 4 is a conceptual diagram illustrating a fourth exemplary embodiment of a wireless communication network.

Referring to FIG. 4, the first terminal 110 may be located within the cell coverage of the first base station 100, and the second terminal 210 may be located within a cell coverage of a second base station 200. When the first terminal 110 has a frame to be transmitted to the second terminal 210, the first terminal 110 may directly transmit the frame to the second terminal 210. The first terminal 110 may directly receive a frame from the second terminal 210. That is, each of the first terminal 110 and the second terminal 210 may transmit or receive a frame via D2D communications.

A communication node constituting above-described wireless communication network (e.g., the base station, the terminal) may support a communication protocol based on code division multiple access (CDMA), a communication protocol based on wideband CDMA (WCDMA), a communication protocol based on time division multiple access (TDMA), a communication protocol based on frequency division multiple access (FDMA), a communication protocol based on single carrier-FDMA (SC-FDMA), a communication protocol based on orthogonal frequency division multiplexing (OFDM), a communication protocol based on orthogonal frequency division multiple access (OFDMA), and so on.

The base station of the communication node may be referred to a NodeB, an evolved NodeB, a base transceiver station (BTS), a radio base station, a radio transceiver, an access point, an access node, and so on. The terminal may be referred to a UE, an access terminal, a mobile terminal, a station, a subscriber station, a portable subscriber station, a mobile station, a node, a device, and so on. The communication node may have following structure.

FIG. 5 is a block diagram illustrating an exemplary embodiment of a communication node constituting a wireless communication network.

Referring to FIG. 5, a communication node 500 may include at least one processor 510, a memory 520 and a transceiver 530 connected to a network and performing communication. Further, the communication node 500 may include an input interface device 540, an output interface device 550, and a storage device 560. The respective components included in the communication node 500 may be connected via a bus 570 to communicate with each other.

The processor 510 may perform a program command stored in the memory 520 and/or the storage device 560. The processor 510 may be a central processing unit (CPU), a graphics processing unit (GPU) or a dedicated processor in which the methods according to an exemplary embodiment of the present discloser are performed. The memory 520 and the storage device 560 may include a volatile storage medium and/or a nonvolatile storage medium. For example, the memory 520 may include a read only memory (ROM) and/or a random access memory (RAM).

Operation methods of the communication node in the wireless communication network will be described below. Although a method (e.g., signal transmission or reception) performed by a first communication node will be described, a second communication node corresponding thereto may perform a method (e.g., signal reception or transmission) corresponding to the method performed by the first communication node. That is, when an operation of the first terminal is described, the second terminal (or, the base station) corresponding thereto may perform an operation corresponding to the operation of the first terminal. On the contrary, when an operation of the second terminal (or, the base station) is described, the first terminal may perform an operation corresponding to an operation of the second terminal (or, the base station).

Meanwhile, in order to support D2D communications (e.g., group-based D2D communications), the below parameters may be defined. The below parameters may be configured via upper-layer protocols.
Group address for IP: proximity service (ProSe) group IP multicast address
IP version information: IP version 4 (IPv4) or IP version 6 (IPv6)
Group security-related information for multicast

A terminal may perform D2D communications by using an IP address. The IP address may be configured by a network. When the IP address cannot be configured by the network, the terminal may directly configure its IP address (i.e., dynamic configuration). The terminal may support IPv4, IPv6, etc. In a case that IPv4 is used, the terminal may configure an IPv4 link-local address defined in request for comments (RFC) 3927. In this case, the terminal may randomly select an IP address in a range from 169.254.1.0 to 169.254.254.255. In a case that IPv6 is used, the terminal may configure an IPv6 link-local address defined in RFC 4862. The IP address configured by the terminal may collide with an IP address of another terminal. In order to resolve the collision between IP addresses in the D2D communications, an address resolution protocol (ARP) may be used.

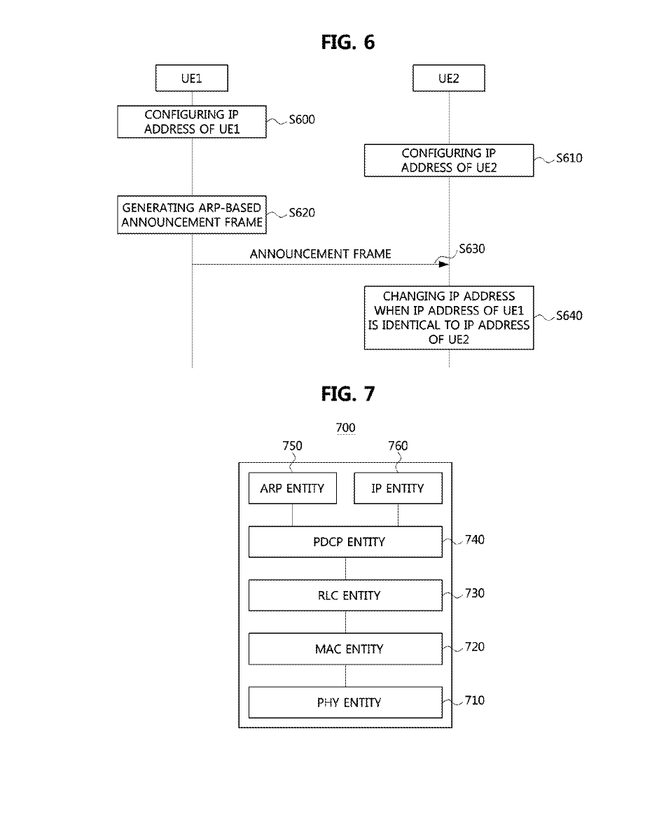

FIG. 6 is a sequence chart illustrating a method of preventing collisions between IP addresses in D2D communications according to an exemplary embodiment of the present disclosure.

Referring to FIG. 6, the first terminal UE1 may be located in a proximity communication range from the second terminal UE2. That is, the first terminal UE1 may perform D2D communications with the second terminal UE2. Here, the first terminal UE1 may be the first terminal 110 explained by referring to FIG. 1 to FIG. 4. Also, the second terminal UE2 may be the second terminal 210 explained by referring to FIG. 1 to FIG. 4. Also, each of the first terminal UE1 and the second terminal UE2 may be constructed identically or similarly to the communication node explained by referring to FIG. 5. Each of the first terminal UE1 and the second terminal UE2 may support ARE Each of the first terminal UE1 and the second terminal UE2 may include the following entities.

FIG. 7 is a block diagram illustrating entities included in a terminal performing D2D communications.

Referring to FIG. 7, a terminal 700 may include a physical layer (PHY) entity 710, a medium access control layer (MAC) entity 720, a radio link control (RLC) entity 730, a packet data convergence protocol (PDCP) entity 740, an ARP entity 750, and an IP entity 760.

The PHY entity 710 may perform a coding operation, a decoding operation, a modulation operation, a demodulation operation, an antenna and resource mapping operation, an antenna and resource demapping operation, etc.

The MAC entity 720 may perform a scheduling operation, a multiplexing operation, a demultiplexing operation, a hybrid automatic repeat request (HARQ) operation, etc. The RLC entity 730 may perform a segmentation operation, a concatenation operation, an ARQ operation, etc. The PDCP entity 740 may perform a header compression operation, a header decompression operation, an integrity protection operation, an integrity verification operation, a ciphering operation, a deciphering operation, etc. The ARP entity 750 may perform operations defined according to ARE The ARP entity 750 may exist separately from the IP entity 760, or exist as embedded in the IP entity 760. The entities included in the terminal 700 are not restricted to the above explained entities, and the terminal 700 may include further various entities according to its necessity.

Re-referring to FIG. 6, the first terminal UE1 may configure its IP address (S600). In a case that the first terminal UE1 supports IPv4, the first terminal UE1 may configure an IPv4 link-local address defined in RFC 3927. For example, the first terminal UE1 may randomly select its IP address among 169.254.1.0 to 169.254.254.255. Alternatively, in a case that the first terminal UE1 supports IPv6, the first terminal UE1 may configure an Ipv6 link-local address defined in RFC 4862. Also, the second terminal UE2 may configure its IP address in an identical or similar manner with the first terminal UE1 (S610). Here, although it is explained that the IP address of the first terminal UE1 is configured before configuration of the IP address of the second terminal UE2, a configuration sequence of the IP addresses is not restricted to the above description. For example, the IP address of the second terminal UE2 may be configured before the IP address of the first terminal UE1 is configured, or configured simultaneously with the IP address of the first terminal UE1. The first terminal UE1 may generate an ARP-based announcement frame when a predetermined event occurs (S620). The predetermined event may be explained as follows.
(Event-1) Completion of configuration for D2D communications
(Event-2) A case that the IP address of the first terminal UE1 has been changed due to IP address collision
(Event-3) A case that a frame including the IP address of the first terminal UE1 has not been transmitted by the first terminal UE1 during a predetermined time.
(Event-4) A case that a source address included in a received frame is identical to the IP address of the first terminal UE1. Here, when a group to which a terminal transmitting the frame including the source address identical to the IP address of the first terminal UE1 belongs is different from a group to which the first terminal UE1 belongs, or when the frame including the source address identical to the IP address of the first terminal UE1 is transmitted in a multicast or broadcast manner, the announcement frame may not be generated.

When the above-described predetermined even occurs, the MAC entity 720 (or, a radio resource management (RRM) entity (not illustrated)) of the first terminal UE1 may generate an indicator instructing to generate an announcement frame. The MAC entity 720 (or, the RRM entity) of the first terminal UE1 may transmit the generated indicator to the ARP entity 750 of the first terminal UE1. Upon receiving the indicator, the ARP entity 750 of the first terminal UE1 may identify that generation of the announce frame is requested, and thus generate the announcement frame. The predetermined events are not restricted to the above-described examples, and may be configured variously.

The announcement frame may include a PDCP header and an ARP packet. The ARP packet may include an ARP header. The PDCP header may be configured by the PDCP entity 740, and the ARP header may be configured by the ARP entity 750. The ARP header configured by the ARP entity 750 may be constructed as follows.

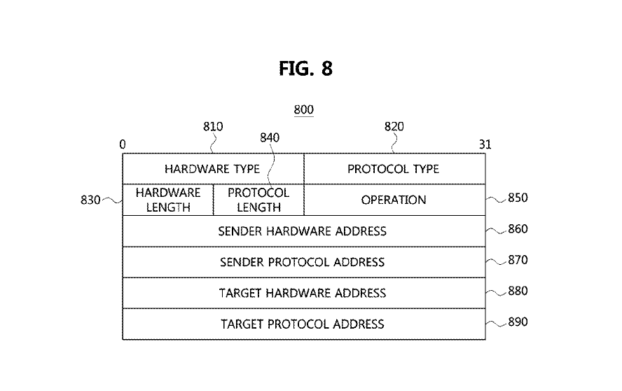

FIG. 8 is a block diagram illustrating an ARP header included in an announcement frame.

Referring to FIG. 8, the ARP header 800 may include a hardware type field (HTYPE) 810, a protocol type field (PTYPE) 820, a hardware length field (HLEN) 830, a protocol length field (PLEN) 840, an operation field (OPER) 850, a sender hardware address field (SHA) 860, a sender protocol address field (SPA) 870, a target hardware address field (THA) 880, and a target protocol address field (TPA) 890.

The HTYPE field 810 may indicate a type of hardware. The hardware type may be configured as represented in the below table 1. For example, when the HTYPE field 810 is set to ‘0x0001,’ the field may indicate an Ethernet hardware.

TABLE 1

| Number | Hardware Type |
|---|---|
| 0 | Reserved |
| 1 | Ethernet (10 Mb) |
| 2 | Experimental Ethernet (3 Mb) |
| 3 | Amateur Radio AX.25 |
| 4 | Proteon ProNET Token Ring |
| 5 | Chaos |
| 6 | IEEE 802 networks |
| 7 | ARCNET |
| 8 | Hyperchannel |
| 9 | Lanstar |
| 10 | Autonet Short Address |

Identically or similarly to the table 1, a value indicating a hardware for long term evolution (LTE) D2D communications may be configured.

The PTYPE field 820 may indicate an IP version. For example, the PTYPE field 820 may indicate IPv4, IPv6, asynchronous transfer mode (ATM), etc. For example, when the PTYPE field 820 is set to ‘0x0800,’ it may indicate IPv4. The HLEN field 830 may indicate the length of hardware address (e.g., MAC address). For example, the HLEN field 830 may have the length of 6 byres for Ethernet environments. The PLEN field 840 may indicate the length of a protocol address (e.g., network-layer address). For example, when IPv4 is used, the PLEN field 840 may have the length of 4 bytes.

The OPER field 850 may indicate a type of the ARP packet. For example, when the OPER field 850 is set to 1, it may indicate an ARP request. When the OPER field 850 is set to 2, it may indicate an ARP reply. When the OPER field 850 is set to 3, it may indicate a reverse ARP (RARP) request. When the OPER field 850 is set to 4, it may indicate a RARP reply. The SHA field 860 may indicate a sender hardware address (e.g., sender MAC address). The SPA field 870 may indicate a sender protocol address (e.g., sender IP address). The THA field 880 may indicate a target hardware address (e.g., target MAC address). The TPA field 890 may indicate a target protocol address (e.g., target IP address).

Re-referring to FIG. 6, the first terminal UE1 (e.g., the ARP entity 750 included in the first terminal UE1) may usually configure the ARP header 800 included in the ARP packet of the announcement frame in one of three manners. In the first manner, when the announcement frame is transmitted through a D2D communication interface (e.g., PC5), the ARP entity 750 of the first terminal UE1 may configure the ARP header 800 as represented in the below table 2.

TABLE 2

| A field included | |
|---|---|
| in an ARP header | Information indicated by field |
| HTYPE field | Hardware for LTE D2D communications |
| PTYPE field | IPv4 |
| HLEN field | 0 bytes |
| PLEN field | 4 bytes |
| OPER field | ARP request |
| SHA field | X (not transmitted) |
| SPA field | All zero |
| THA field | X (not transmitted) |
| TPA field | IP address of UE1 |

In the second manner, when the announcement frame is transmitted through a D2D communication interface (e.g., PC5), the ARP entity 750 of the first terminal UE1 may configure the ARP header 800 as represented in the below table 3.

TABLE 3

| A field included | |
|---|---|
| in an ARP header | Information indicated by field |
| HTYPE field | Hardware for LTE D2D communications |
| PTYPE field | IPv4 |
| HLEN field | The length of source layer-2 ID (e.g., 3 bytes) |
| PLEN field | 4 bytes |
| OPER field | ARP request |
| SHA field | predetermined values (e.g., all zero) |
| SPA field | All zero |
| THA field | predetermined values (e.g., all zero) |
| TPA field | IP address of UE1 |

For D2D communications, a source layer-2 identifier (ID) and a ProSe layer-2 group ID may be used. The source layer-2 ID may be a layer-2 identifier of the first terminal UE1 which is used for D2D communications, and may be a unique identifier in a group. The ProSe layer-2 group ID may be a destination identifier for group-based D2D communications. In the third manner, when the announcement frame is transmitted through a D2D communication interface (e.g., PC5), the ARP entity 750 of the first terminal UE1 may configure the ARP header 800 as represented in the below table 4. Here, the THA field 880 of the ARP header 800 may be configured as a ProSe layer-2 group ID instead of predetermined values (e.g., all zero).

TABLE 4

| A field included | |
|---|---|
| in an ARP header | Information indicated by field |
| HTYPE field | Hardware for LTE D2D communications |
| PTYPE field | IPv4 |
| HLEN field | The length of source layer-2 ID (e.g., 3 bytes) |
| PLEN field | 4 bytes |
| OPER field | ARP request |
| SHA field | Source layer-2 ID |
| SPA field | All zero |
| THA field | predetermined values (e.g., all zero) |
| TPA field | IP address of UE1 |

In the tables 2 to 4, the OPER field 850 of the ARP header 800 may indicate ARP reply, RARP request, or RARP reply as well as ARP request.

The ARP entity 750 of the first terminal UE1 may transmit the ARP packet including the ARP header 800 generated in the above-described manner to the PDCP entity 740 of the first terminal UE1. Here, the PDCP entity 740 of the first terminal UE1 may be used for broadcast transmission. The PDCP entity 740 may be explained as follows.

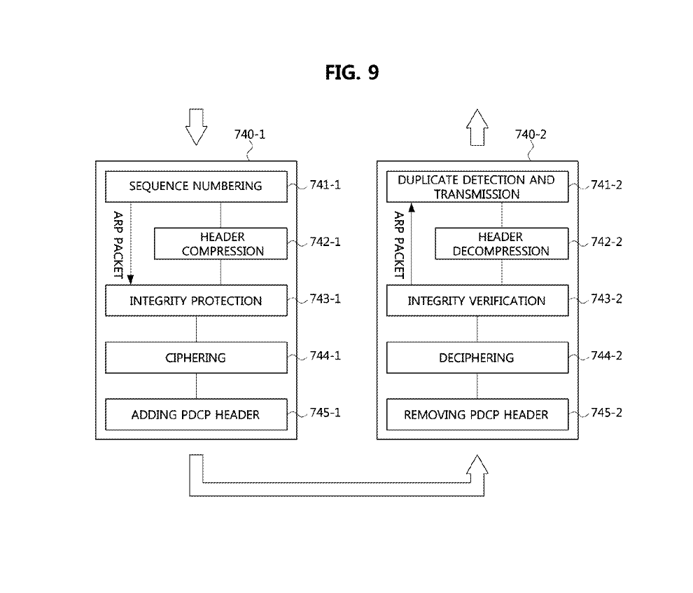

FIG. 9 is a block diagram illustrating a PDCP entity included in a terminal.

Referring to FIG. 9, a first PDCP entity 740-1 may be included in the first terminal UE1, and a second PDCP entity 740-2 may be included in the second terminal UE2. The first PDCP entity 740-1 may include a sequence numbering entity 741-1, a header compression entity 742-1, an integrity protection entity 743-1, a ciphering entity 744-1, and a PDCP header related entity 745-1. The sequence numbering entity 741-1 may perform sequence numbering operations on packets (e.g., ARP packets, IP packets, etc.) received from upper entities such as the ARP entity 750 and the IP entity 760. The header compression entity 742-1 may perform header compression on IP packets, and may not perform header compression on packets other than IP packets (e.g., ARP packets). That is, ARP packets may be transmitted from the sequence numbering entity 741-1 to the integrity protection entity 743-1 through a bearer.

The integrity protection entity 743-1 may perform integrity protection operations on ARP packets or IP packets. The ciphering entity 744-1 may perform ciphering operations on ARP packets or IP packets. The PDCP header related entity 745-1 may add a PDCP header to each of the ARP packets or the IP packets. The ARP packets or IP packets to which the PDCP header is added may be transmitted to the second terminal UE2 through a RLC entity, a MAC entity, and a PHY entity of the first terminal UE1.

The second PDCP entity 740-2 may include a duplicate detection and transmission entity 741-2, a header decompression entity 742-2, an integrity verification entity 743-2, a deciphering entity 744-2, and a PDCP header related entity 745-2. The PDCP header related entity 745-2 may remove the PDCP header from packets received from the lower entity (e.g., RLC entity). The deciphering entity 744-2 may perform deciphering operations on the ARP packets or IP packets whose PDCP header is removed. The integrity verification entity 743-2 may perform integrity verification operations on the ARP packets or IP packets.

The header decompression entity 742-2 may perform header decompression operations on IP packets, and may not perform header decompression operations on packets other than the IP packets (e.g., ARP packets). That is, ARP packets may be transmitted from the integrity verification entity 743-2 to the duplicate detection and transmission entity 741-2 through a bearer. The duplicate detection and transmission entity 741-2 may perform duplicate detection operations on ARP packets or IP packets, and transfer the ARP packets or IP packets to the upper entities such as the ARP entity and the IP entity according their sequence.

Re-referring to FIG. 6, the PDCP entity 740 of the first terminal UE1 may not perform header compression on ARP packets. That is, ARP packets may be mapped to a bearer on which header compression operations are not performed. The PDCP entity 740 of the first terminal UE1 may perform integrity protection, ciphering, etc. on ARP packets. The bearer for ARP packets may be configured in advanced. The PDCP entity 740 of the first terminal UE1 may add a PDCP header to each of ARP packets. The PDCP header may be constructed as follows.

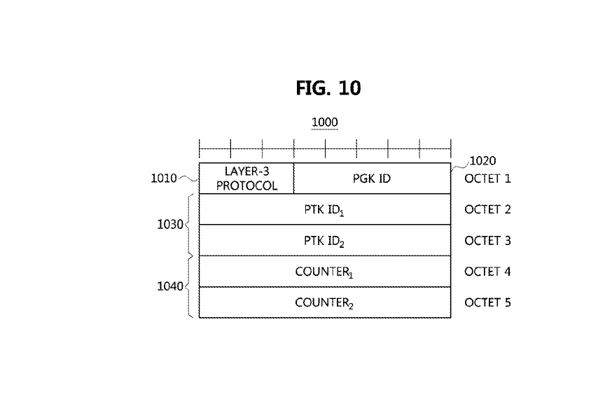

FIG. 10 is a block diagram illustrating a PDCP header included in an announcement frame.

Referring to FIG. 10, a PDCP header 1000 may include a layer-3 protocol field 1010, a ProSe group key (PGK) ID field 1020, a ProSe traffic key (PTK) ID field 1030, and a counter field 1040. The layer-3 protocol field 1010 may have the length of 3 bits, and be used for discriminating IP packets and ARP packets. The PGK ID field 1020 may have the length of 5 bits, and may mean one identifier among ProSe group keys corresponding to a specific communication group (e.g., layer-2 target ID).

The PTK ID field 1030 may have the length of 16 bits, and may indicate a PTK ID. The PTK may be uniquely identified using a combination of a group identifier (e.g., layer-2 target ID), a PGK ID, a group member ID (e.g., layer-2 source ID), and a PTK ID. The counter field 1040 may have the length of 16 bits, and may be used with a specific PTK for guaranteeing key stream freshness.

Re-referring to FIG. 6, the PDCP header 740 of the first terminal UE1 may transmit ARP packets to which the PDCP header is added to the RLC entity 730 of the first terminal UE1. The RLC entity 730 of the first terminal UE1 may be used for broadcast transmission. The RLC entity 730 of the first terminal UE1 may perform processing on data units (i.e., PDCP header+ARP packet) received from the PDCP entity 740, and transmit the processed data units to the MAC entity 720 of the first terminal UEL The MAC entity 720 of the first terminal UE1 may be used for broadcast transmission. The MAC entity 720 of the first terminal UE1 may perform processing on data units received from the RLC entity 730 of the first terminal UE1. For example, the MAC entity 720 of the first terminal UE1 may generate an announcement frame including the data units.

The announcement frame may include a radio bearer identifier (RBID) and a logical channel index (LCID) for the above-described ARP packet. The RBID and LCID may be configured for terminals performing D2D communications in advance. In the case that the RBID and LCID are configured in advance (i.e., a case that terminals performing D2D communications already know the preconfigured RBID and LCID), the announcement frame may not include the RBID and LCID. On the contrary, in the case that the RBID and LCID are not configured in advanced, the announcement frame may include the RBID and LCID.

The first terminal UE1 (e.g., the PHY entity 710 of the first terminal UE1) may transmit the announcement frame (S630). The announcement frame may be transmitted in multicast manner or broadcast manner. The terminal (e.g., the second terminal UE2) located in a proximity communication range from the first terminal UE1 may receive the announcement frame. The second terminal UE2 may identify that which packet (e.g., IP packet or ARP packet) is included in the announcement frame by identifying the layer-3 protocol field 910 included in the PDCP header 900 of the received announcement frame. For example, when the layer-3 protocol field 910 of the PDCP header 900 in the announcement frame indicates that the announcement frame includes an IP packet, the second terminal UE2 may process the announcement frame according to an IP packet processing procedure. On the contrary, when the layer-3 protocol field 910 of the PDCP header 900 in the announcement frame indicates that the announcement frame includes an ARP packet, the second terminal UE2 may process the announcement frame according to the following procedure.

When the announcement frame includes the RBID and LCID, the second terminal UE2 may process the PDCP header 900 and the ARP packet included in the announcement frame based on the RBID and LCID. On the contrary, when the announcement frame does not include the RBID and LCID, the second terminal UE2 may process the PDCP header 900 and the ARP packet included in the announcement frame based on the RBID and LCID which are configured in advance. Here, although integrity verification and deciphering may be performed on the ARP packet included in the announcement frame, header decompression may not be performed on the ARP packet included in the announcement frame. That is, the ARP packet may be mapped to a bearer to which header decompression operation is not applied. The PDCP entity 740 of the second terminal UE2 may transmit the ARP packet to the ARP entity 750.

The ARP entity 750 of the second terminal UE2 may receive the ARP packet from the PDCP entity 740, and obtain the ARP header from the ARP packet. When the ARP header is configured according to one of the above-described tables 2 to 4, the ARP entity 750 of the second terminal UE2 may identify that the frame in which the ARP header is included is the announcement frame. For example, the ARP entity 750 of the second terminal UE2 may identify that the hardware for LTE D2D communications is used based on the HTYPE field 810 included in the ARP header 800. Also, the ARP entity 750 of the second terminal UE2 may identify that the frame in which the ARP header is included in the announcement frame according to the value configured in each of the HLEN field 830, the SHA field 860, and the THA field 880 included in the ARP header 800. The ARP entity 750 of the second terminal UE2 may identify the value configured in the TPA field 890 included in the ARP header 800. That is, since the TPA filed 890 is set to the IP address of the first terminal UE1 transmitting the announcement frame in which the ARP header 800 is included, the second terminal UE2 may identify the IP address of the first terminal UE1 based on the TPA field 890.

The second terminal UE2 may determine whether its IP address is identical to the IP address of the first terminal UE1. When the IP address of the first terminal UE1 is identical to the IP address of the second terminal UE2, the second terminal UE2 may change its IP address (S640). In this case, the second terminal UE2 may reconfigure its IP address according to the above-described step S610. On the other hand, when the IP addresses of two terminals are identical, but the second terminal UE2 cannot change its IP address, the second terminal UE2 may generate a request frame requesting the first terminal UE1 to change the IP address of the first terminal UE1, and transmit the request frame to the first terminal UE1. Upon receiving the request frame, the first terminal UE1 may identify that the change of its IP address is requested. Also, the first terminal UE1 may identify that IP addresses of two terminals are identical. Thus, in response to the request, the first terminal UE1 may change its IP address, and notify the changed IP address to other terminals by using the above-described announcement frame.

The methods according to embodiments of the present invention may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present invention or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the operation of the present invention, and vice versa.

According to an embodiment of the present invention, it is possible to easily determine a state (that is, a normal state or a fault state) of each of communication nodes constituting a vehicle network and a state of a channel (or port) to which the communication node is connected. A communication node and channel in a fault state may be quickly repaired based on the determination result. Thus the performance of the vehicle network may be enhanced.

While the example embodiments of the present invention and their advantages have been described in detail, it should be understood that various changes, substitutions and alterations may be made herein without departing from the scope of the invention.

What is claimed is:

1. An operation method of a first terminal in a wireless communication network, the method comprising:
configuring an internet protocol (IP) address of the first terminal used for device-to-device (D2D) communications;
generating an address resolution protocol (ARP) based announcement frame including the IP address; and
transmitting the announcement frame.

2. The operation method according to claim 1, wherein the announcement frame includes a packet data convergence protocol (PDCP) header, and the PDCP header includes an indicator indicating that the announcement frame includes an ARP packet.

3. The operation method according to claim 1, wherein the announcement frame includes an ARP packet, and a hardware type field included in an ARP header of the ARP packet indicates a hardware used for the D2D communications.

4. The operation method according to claim 1, wherein the announcement frame includes an ARP packet, and a target protocol address field included in an ARP header of the ARP packet includes the IP address.

5. The operation method according to claim 1, wherein the first terminal includes a medium access control (MAC) entity and an ARP entity, and the MAC entity transmits an indicator instructing to generate the announcement frame to the ARP entity.

6. The operation method according to claim 1, wherein the first terminal includes a PDCP entity, and the PDCP entity does not perform header compression on an ARP packet included in the announcement frame.

7. The operation method according to claim 1, wherein the announcement frame includes a radio bearer identifier (RBID) and a logical channel index (LCID).

8. The operation method according to claim 1, wherein the announcement frame is generated after completion of configuration for the D2D communications.

9. The operation method according to claim 1, wherein the announcement frame is generated when the IP address is a reconfigured IP address due to IP address collision.

10. The operation method according to claim 1, wherein the announcement frame is generated when a frame including the IP address has not been transmitted by the first terminal during a predetermined time.

11. The operation method according to claim 1, wherein the announcement frame is generated when a source address of a frame received from another terminal is identical to the IP address.

12. An operation method of a first terminal in a wireless communication network, the method comprising:
configuring an internet protocol (IP) address of the first terminal used for device-to-device (D2D) communications;
receiving an address resolution protocol (ARP) based announcement frame including an IP address of a second terminal; and
determining whether the IP address of the first terminal is identical to the IP address of the second terminal or not.

13. The operation method according to claim 12, wherein the announcement frame includes a packet data convergence protocol (PDCP) header, and the PDCP header includes an indicator indicating that the announcement frame includes an ARP packet.

14. The operation method according to claim 12, wherein the announcement frame includes an ARP packet, and a hardware type field included in an ARP header of the ARP packet indicates a hardware used for the D2D communications.

15. The operation method according to claim 12, wherein the announcement frame includes an ARP packet, and a target protocol address field included in an ARP header of the ARP packet includes the IP address of the second terminal.

16. The operation method according to claim 12, wherein the first terminal includes a PDCP entity, and the PDCP entity does not perform header compression on an ARP packet included in the announcement frame.

17. The operation method according to claim 12, wherein the announcement frame includes a radio bearer identifier (RBID) and a logical channel index (LCID).

18. The operation method according to claim 12, further comprising changing the IP address of the first terminal when the IP address of the first terminal is identical to the IP address of the second terminal.

19. The operation method according to claim 12, further comprising transmitting a request frame requesting to change the IP address of the second terminal to the second terminal when the IP address of the first terminal is identical to the IP address of the second terminal.
